(19) United States
(12) Patent Application Publication
(10) Pub. No.: US 2008/0231955 A1
(43) Pub. Date: Sep. 25, 2008

(54) Image stabilizing actuator and camera furnished therewith

(76) Inventor: Hiroshi Otsuka, Saitama-shi (JP)

Correspondence Address: JACOBSON HOLMAN PLLC, 400 SEVENTH STREET N.W., SUITE 600, WASHINGTON, DC, 20004, US

(21) Appl. No.: 12/073,937

(22) Filed: Mar. 12, 2008

(30) Foreign Application Priority Data
Mar. 20, 2007 (JP) 2007-072823

(51) Int. Cl. G02B 27/64

(52) U.S. Cl. 359/557

(57) ABSTRACT

Problem: To provide an actuator capable of preventing damage to spherical bodies and their receiving surfaces when subjected to a shock force.

Solution Means: The present invention is an actuator (10) for stabilizing images by moving an imaging lens, comprising a fixed portion (12), a movable portion (14) to which an imaging lens is attached, a plurality of spherical bodies (18) for supporting the movable portion, a fixed portion spherical body receiving surface (28b) disposed on the fixed portion and contacting the spherical bodies, a movable portion spherical body receiving surface (30b) disposed on the movable portion and contacting the spherical bodies, a biasing means (26) for sandwiching the spherical bodies between the fixed portion spherical body receiving surface and the movable portion spherical body receiving surface, and spherical body receiving surface protection means (29, 30) which, when image stabilization control is not in effect, reduce the contact pressure acting on the spherical bodies so as to sandwich the spherical bodies when the movable portion is moved to a predetermined protected position.

### TECHNICAL FIELD

The present invention relates to an actuator and a camera provided therewith, and in particular to an actuator for moving an imaging lens within a plane perpendicular to its optical axis to prevent image blurring, and a camera furnished therewith.

### BACKGROUND ART

A lens shifting device (actuator) is set forth in JP H.10-319465 (Patent Document 1). In this lens shifting device, a moving frame attached to a compensating lens is supported by three steel balls so as to be able to move in parallel, and is driven by a linear motor to prevent image blurring. In this type of lens shifting device, virtually no rubbing resistance arises when the moving frame moves, therefore the moving frame can be driven with a small drive force.

### Patent Document 1

JP H.10-319465

### DISCLOSURE OF THE INVENTION

### Problems to Be Solved by the Invention

However, with the type of actuator set forth in JPH10-319465, the problem arises that receiving surfaces are prone to damage due to the extremely small contacting surface area between the steel balls (spherical bodies) and the steel ball receiving surfaces. That is, a shock force based on the inertial force acting on the moving frame or the like acts on the steel balls and the receiving surfaces thereof when a large shock force acts on a camera, such as when a camera incorporating an actuator is dropped. This shock force causes a large pressure to be generated, particularly between the small contact surface area steel balls and the receiving surfaces thereof, so that in some cases the receiving surfaces plastically deform under this pressure, and strike marks are left on the steel balls. Strike marks formed on the receiving surfaces increase the rolling resistance of the steel balls with respect to the receiving surface and adversely affect control of the moving frame due to the sudden change in the rolling resistance around the strike marks. Moreover, because the receiving surface deforms, the parallelness of the compensating lens attached to the moving frame degrades, leading to the problem of reduced quality of the focused image.

Therefore the present invention has the object of providing an actuator capable of preventing damage to the spherical bodies and receiving surfaces thereof when a shock force is applied, and a camera furnished therewith.

### Means for Solving the Problems

In order to solve the above-described problems, the present invention is an actuator for moving an imaging lens within a plane perpendicular to its optical axis to prevent image blurring, the actuator comprising: a fixed portion; a movable portion to which the imaging lens is attached; a plurality of spherical bodies supporting the movable portion in such a way that it can move on a plane parallel to the fixed portion; a drive means for driving the movable portion with respect to the fixed portion; a fixed portion spherical body receiving surface disposed on the fixed portion and contacting the spherical bodies; a movable portion spherical body receiving surface disposed on the movable portion and contacting the spherical bodies; a biasing means for generating a biasing force to cause the movable portion and the fixed portion to approach one another to sandwich the spherical bodies between the fixed portion spherical body receiving surface and the movable portion spherical body receiving surface; and a spherical body receiving surface protection means to reduce contact pressure acting on the spherical bodies to sandwich the spherical bodies when the movable portion is moved to a predetermined protected position and not under image stabilization control.

In the present invention thus constituted, the movable portion to which the imaging lens is attached is supported by a plurality of spherical bodies so as to be capable of moving on a plane parallel to the fixed portion. Each spherical body is sandwiched between the fixed portion spherical body receiving surface of the fixed portion and the movable portion spherical body receiving surface of the movable portion by the biasing force of the biasing means. When the movable portion is moved to a predetermined protected position in the absence of image stabilization control, the spherical body receiving surface protection means reduces the contact pressure between the spherical bodies and the fixed portion spherical body receiving surfaces and movable portion spherical body receiving surfaces which sandwich the spherical bodies.

In the invention thus constituted, the spherical body receiving surface protection means reduces the contact pressure between the spherical bodies and the receiving surfaces thereof, and damage to the spherical bodies and the receiving surfaces thereof can be therefore prevented when a shock force or the like is applied.

In the present invention, the spherical body receiving surface protection means preferably comprising protuberances formed on the movable portion and the fixed portion, the protuberances contacting one another when the movable portion is moved to the protected position, thereby widening the gap between the fixed portion spherical body receiving surface and the movable portion spherical body receiving surface.

In the present invention thus constituted, the gap between the fixed portion spherical body receiving surfaces and the movable portion spherical body receiving surfaces is widened by the protuberances, thereby enabling the contact pressure sandwiching the spherical bodies to be reduced to essentially zero.

In the present invention, the protuberance is preferably provided with a protuberance sloped surface, formed to connect to the top surface thereof, so that the movable portion is moved to the protected position as it slides on the protuberance sloped surface to widen the gap between the fixed portion spherical body receiving surface and the movable portion spherical body receiving surface.

In the present invention thus constituted, the movable portion is moved to the protected position while sliding on the protuberance sloped surface, therefore the gap between the fixed portion spherical body receiving surfaces and the movable portion spherical body receiving surfaces can be smoothly widened.

In the present invention, the spherical body receiving surface protection means preferably comprises a spherical body escape concavity formed in such a way that the spherical body escape concavity connects to at least either the fixed portion spherical body receiving surface or the movable portion spherical body receiving surface, and the spherical bodies are moved to the spherical body escape concavity when the movable portion is moved to the protected position, placing the fixed portion and the movable portion in direct mutual contact.

In the present invention thus constituted, the fixed portion and the movable portion contact one another directly in the protected position, therefore the thickness of the actuator in the protected position can be reduced.

In the present invention, the spherical body receiving surface protection means preferably comprises a protected position biasing means for biasing the movable portion toward the protected position, and load sharing surfaces respectively provided on the fixed portion and the movable portion, and wherein the load sharing surfaces are pushed against one another by means of a biasing force from the protected position biasing means.

In the present invention thus constituted, the load sharing surfaces disposed on the fixed portion and the movable portion contact one another in the protected position, therefore a portion of the force sandwiching the spherical bodies is also shared by the load sharing surfaces. The contact pressure applied to the spherical bodies is thus reduced.

In the present invention thus constituted, the spherical bodies are also sandwiched in the protected position, therefore an actuator in the protected position can be quickly restored to image stabilization control.

In the present invention, the spherical body receiving surface protection means preferably comprise a spherical body support surface portion formed to connect with at least one of the movable portion spherical body receiving surface and the fixed portion spherical body receiving surface, wherein the spherical body support surface portion contacts the spherical body when the movable portion is moved to the protected position, and wherein the contact surface area between the spherical body support surface portion and the spherical body is greater than the contact surface area between the fixed portion spherical body receiving surface or the movable portion spherical body receiving surface and the spherical body.

In the present invention thus constituted, the contact surface area between the spherical body support surface portion and the spherical bodies in the protected position becomes broader than the contact surface area of the fixed portion spherical body receiving surface or the movable portion spherical body receiving surface with the spherical bodies, thereby reducing the contact pressure acting on the spherical bodies.

In the present invention thus constituted, the spherical bodies are supported by the spherical body support surface portions, therefore the spherical bodies can be held in the protected position.

The camera of the present invention also comprises a lens barrel; a plurality of imaging lenses housed within the lens barrel; the actuator of the present invention wherein at least one of these imaging lenses is attached to the movable portion; and a camera main body.

### Effect of the Invention

The actuator and the camera provided therewith of the present invention enable the prevention of damage to the spherical bodies and their receiving surfaces when a shock force is applied.

### Best Mode for Practicing the Invention

We next discuss preferred embodiments of the present invention with reference to the attached figures. First we discuss a first embodiment of the present invention with reference to FIGS. 1 through 7. FIG. 1 is a cross sectional view of the camera of this embodiment.

As shown in FIG. 1, a camera 1 of the first embodiment has a lens unit 2 and a camera main body 4. The lens unit 2 has a lens barrel 6, a plurality of imaging lenses 8 arrayed within the lens barrel, an actuator 1 0 for moving a image blur compensation lens 16 among the imaging lenses 8 within a predetermined plane, and gyros 34a and 34b (only 34a is shown in FIG. 1) serving as a vibration detection means for detecting vibration in the lens barrel 6.

The lens unit 2 is attached to the camera main body 4 and constituted so that entering light is imaged on a film surface F.

The approximately cylindrical lens barrel 6 holds within it a plurality of the imaging lenses 8, and focusing is performed by moving a portion of the imaging lenses 8.

The camera 1 of the present embodiment of the invention detects vibration using the gyros 34a and 34b and, based on the detected vibration, activates the actuator 10 and moves the image blur compensation lens 16 to stabilize the image focused on the film surface F within the camera main body 4. In the present embodiment a piezoelectric vibrating gyro is used for the gyros 34a and 34b. Note that in the present embodiment the image blur compensation lens 16 comprises a single lens, but the lens used to stabilize the image may also be a lens group of multiple lenses.

Next we discuss the constitution of the actuator 10 with reference to FIGS. 2 through 7. FIG. 2 is a front elevation of the actuator 10 with the moving frame at the image stabilization control operational center position.

As shown in FIGS. 2 and 3, the actuator 10 has a fixed frame 12 serving as a fixed portion affixed within the lens barrel 6, a moving frame 14 serving as a movable portion supported so as to be movable with respect to the fixed frame 12, and three steel balls 18 serving as spherical bodies supporting the moving frame 14.

The actuator 10 is constituted to move the moving frame 14 with respect to the fixed frame 12 affixed to the lens barrel 6 within a plane parallel to the film surface F. The actuator 10, by moving the image blur compensation lens 16 attached to the moving frame 14, is controlled such that the image formed on the film surface F is not distorted even if the lens barrel 6 vibrates. At the same time, the actuator 10 is constituted in such a way that the receiving surface for the steel balls 18 is protected by moving the moving frame 14 to the protected position shown by the imaginary line in FIG. 2 when not under image blur compensation control.

Moreover, the actuator 10 has two drive coils 20a and 20b attached to the fixed frame 12, and two drive magnets 22a and 22b attached at positions respectively corresponding to the drive coils 20a and 20b. Note that the drive coils 20a and 20b and the two drive magnets 22a and 22b attached thereto constitute a linear motor, and function as a drive means for driving the moving frame 14 with respect to the fixed frame 12.

Furthermore, the actuator 10 has two coil springs 26, which are the biasing means for generating biasing force so that the moving frame 14 and the fixed frame 12 approach one another.

Additionally, Hall elements 24a and 24b, which are magnetic sensors, are respectively arrayed inside the windings of the drive coils 20a and 20b. Each Hall element 24a and 24b detects magnetism of the drive magnets 22a and 22b arrayed so as to face the Hall elements 24a and 24b, thereby detecting the position of the moving frame 14 with respect to the fixed frame 12.

As shown in FIG. 1, the actuator 10 has a controller 36, which is a control means for controlling the electrical current flowing to the drive coils 20a and 20b based on the vibration detected by the gyros 34a and 34b and on moving frame 14 positional information detected by the Hall elements 24a and 24b.

The fixed frame 12 has a generally flat donut shape, on which fixed frame concavities 28 for receiving the steel balls 18 are formed at three locations on the perimeter around the optical axis. Details of the fixed frame concavities 28 are discussed below.

The moving frame 14 has a generally flat donut shape, and is disposed in parallel to the fixed frame 12. An image blur compensation lens 16 is attached at the middle opening on the moving frame 14. Moving frame concavities 30 are formed at positions on the moving frame 14 corresponding to the respective fixed frame concavities 28 so as to face the fixed frame concavities 28. Details of the moving frame concavities 30 are discussed below.

The steel balls 18, as shown in FIG. 3, are disposed between the fixed frame 12 and the moving frame 14. Three steel balls 18 are provided, as shown in FIG. 2, respectively separated by a center angle of 120° and received by the fixed frame concavities 28 and the moving frame concavities 30. Moreover, the steel balls 18 are sandwiched between the fixed frame 12 and the moving frame 14 by the biasing force generated by the coil springs 26. The moving frame 14 is thus supported on a plane parallel to the fixed frame 12, and movement of the moving frame 14 with respect to the fixed frame 12 is allowed by the rolling of each of the steel balls 18 as they continue to be enclosed.

The two drive coils 20a and 20b are respectively disposed on the fixed frame 12. In the present embodiment, the drive coil 20a is disposed vertically above the optical axis, and the drive coil 20b is separated by a 90° center angle gap from the drive coil 20a. That is, the drive coils 20a and 20b are respectively disposed on a vertical axial line and a horizontal axial line intersecting at the optical axis.

The drive magnets 22a and 22b respectively have an elongated rectangular shape, and are recessed into the moving frame 14. The drive magnets 22a and 22b are arrayed at positions corresponding to the moving frame 14 drive coils 20a and 20b, with the long sides of the elongated rectangles oriented in a direction tangential to a circle centered on the optical axis of the lens unit 2. In this constitution, the flow of current in each of the coils generates a drive force between each coil and its corresponding drive magnet, thereby driving the moving frame 14.

Next we discuss detection of the moving frame 14 position.

The sensitivity center point of the Hall element 24a at the operational center point position of the image blur compensation control is on the magnetization boundary line of the drive magnet 22a. In this case, the drive magnet 22a is moved together with the moving frame 14 from the operational center position, and the output signal of the Hall element 24a changes when the Hall element 24a sensitivity center point moves off of the drive magnet 22a magnetization boundary line.

In cases where the amount of movement of the drive magnets 22a and 22b is very small, the Hall element 24a outputs a signal which is essentially proportional to the distance moved by the drive magnet 22a. In the present embodiment, if the movement distance of the drive magnet 22a is within approximately 3% of the length of the long side of the drive magnet 22a, the signal output from the Hall element 24a will be essentially proportional to the distance between the Hall element 24a sensitivity center point and the drive magnet 22a magnetization boundary line. In the present embodiment, within the operating region of the image blur compensation control the actuator 10 operates in a range in which the output of each Hall element is essentially proportional to movement distance.

We have discussed the Hall element 24a; the Hall element 24b outputs a similar signal based on the positional relationship with the corresponding drive magnet 22b. It is therefore possible to identify the position to which the moving frame 14 has moved with respect to the fixed frame 12 based on the signal detected by each of the Hall elements 24a and 24b.

Next, referring to FIGS. 4 through 7, we discuss the constitution of the fixed frame concavity 28 and the moving frame concavity 30 for receiving the steel balls 18. FIG. 4(a) is a plan view of a fixed frame concavity 28; FIG. 4(b) is a sectional view along line b-b in (a). FIG. 5(a) is a plan view of the moving frame concavity 30; FIG. 5(b) is a sectional view along line b-b in (a). FIG. 6 is a figure showing a section along line VI-VI in FIG. 2 at the actuator 10 operational center position in (a) and at the protected position in (b). FIG. 7 is a plan view showing the fixed frame concavity 28 and the moving frame concavity 30 in the protected position.

As shown in FIG. 4(a), the fixed frame concavity 28 is a concavity with a generally circular cross section, constituted so that the steel ball 18 is disposed therein. An outrigger portion 28a, protruding from_the fixed frame concavity 28, is formed at one location on the perimeter of the fixed frame concavity 28; this outrigger portion 28a protrudes in the direction of the protected position motion axis A. The movement of the moving frame 14 along this protected position motion axis A results in the movement of the moving frame 14 from the operational center position to the protected position. The planar bottom surface of the fixed frame concavity 28 constitutes a fixed portion spherical body receiving surface 28b for making contact with the steel balls 18. Protuberances 29a and 29b are respectively disposed on both sides of the fixed frame concavity 28. These protuberances 29a and 29b are positioned so that the outrigger portion 28a aligns with the protruding protected position motion axis A.

As shown in FIG. 4(b), one of the protuberances 29a is disposed adjacent to the fixed frame concavity 28, and the other protuberance 29b is disposed at a certain interval apart from the fixed frame concavity 28. Moreover, the protuberance 29a has a flat top surface 29a1 formed to be parallel to the protuberance 29b, and a protuberance sloped surface 29a2 formed to be contiguous with the top surface 29a1 on the opposite side of the fixed frame concavity 28. The protuberance 29b has a flat top surface 29b1 formed parallel to the fixed portion spherical body receiving surface 28b, and a protuberance sloped surface 29b2 formed to be contiguous with the top surface 29b1 on the side of the fixed frame concavity 28.

At the same time, as shown in FIG. 5(a), the moving frame concavity 30 is generally circular in section, constituted so that the steel ball 18 is disposed within this concavity. An outrigger portion 30a, protruding so that it bulges at the tip, is formed at one location on the perimeter of the moving frame concavity 30, and the planar bottom surface of the moving frame concavity 30 constitutes a movable portion spherical body receiving surface 30b for contacting the steel ball 18. The outrigger portion 30a is formed to protrude in the opposite direction to the corresponding fixed frame concavity 28 outrigger portion 28a. Additionally, these protuberances 31a and 31b are positioned to align with the protected position motion axis A protruding from the outrigger portion 30a.

As shown in FIG. 5(b), one of the protuberances 31b corresponding to the protuberance 29b is disposed adjacent to the moving frame concavity 30, and the protuberance 31a corresponding to the other protuberance 29a is disposed at a predetermined interval from the moving frame concavity 30. Moreover, the protuberance 31a has a flat top surface 31a1 formed parallel to a movable portion spherical body receiving surface 30b, and a protuberance sloped surface 31a2 formed contiguously with the top surface 31a1 on the side of the moving frame concavity 30. The protuberance 31b has a flat top surface 31b1 formed parallel to the movable portion spherical body receiving surface 30b, and a protuberance sloped surface 31a2 formed to be contiguous with the top surface 31a1 on the moving frame concavity 30 side. The protuberance 31b has a flat top surface 31b1 formed parallel to the movable portion spherical body receiving surface 30b, and a protuberance sloped surface 31b2 formed to be contiguous with the top surface 31b1.

Note that the three fixed frame concavities 28 formed on the fixed frame 12, and the three moving frame concavities 30 formed on the moving frame 14, are respectively formed in the same shape. Each of the fixed frame concavities 28 and the moving frame concavities 30 are formed as shown in FIG. 2, so that the protected position movement axes A thereof are mutually parallel. Each of the protuberances 29a, 29b, 31a, and 31b functions as a spherical body receiving surface protection means.

As shown in FIG. 6(a), when the actuator 10 executes image stabilization control, a steel ball 18 is sandwiched between the fixed portion spherical body receiving surface 28b and the movable portion spherical body receiving surface 30b. When this happens, the protuberance 29a sloped surface 29a2 and the protuberance 31a sloped surface 31a2 face one another, and the protuberance 29b sloped surface 29b2 and the protuberance 31b sloped surface 31b2 face one another. Note that there is no mutual contact between each of the protuberances within the range of movement in which the moving frame 14 moves under image stabilization control.

Next, when the moving frame 14 is moved in what is shown as the lateral direction in FIG. 6(a) along the protected position motion axis A, the protuberance sloped surface 29a2 contacts the protuberance sloped surface 31a2, and the protuberance sloped surface 29b2 contacts the protuberance sloped surface 31b2. This causes the moving frame 14 to rise on the sloped surface in opposition to the biasing force of the coil spring 26, such that the gap between the moving frame 14 and the fixed frame 12 widens.

As shown in FIG. 6(b), when the moving frame 14 is moved up to the steel ball 18 protected position, the top surface 29a1 contacts the top surface 31a1, and the top surface 29b1 contacts the top surface 31b1. In this protected position, the gap between the fixed portion spherical body receiving surface 28b and the movable portion spherical body receiving surface 30b becomes larger than the diameter of the steel ball 18, therefore the contact pressure by which the fixed frame 12 and the moving frame 14 sandwich the steel ball 18 is reduced to zero.

Furthermore, as shown in FIG. 7, in the steel ball 18 protected position the steel ball 18 is moved to a relatively small space around which the fixed frame concavity 28 outrigger portion 28a overlaps with the moving frame concavity 30 outrigger portion 30a; within this space the steel ball is able to move freely.

Next we discuss the operation of the actuator 10. First, under image stabilization control, vibration of the lens unit 2 is continuously detected by the two gyros 34a and 34b, and is input to the controller 36. In the present embodiment, the gyros 34a and 34b are constituted and disposed to respectively detect the angular velocities of the lens unit 2 yawing and pitching motions.

The controller 36 performs a time integration of the angular velocities input instant by instant from the gyros 34a and 34b and a predetermined optical characteristic correction to generate a lens position command signal horizontal component Dx and vertical component Dy. Current is sourced to each of the drive coils 20a and 20b in response to the lens position command signals thus obtained in order to drive the moving frame 14 and instantaneously move the image blur compensation lens 16 attached thereto. By this means, images focused on the film surface F inside the camera main body 4 can be stabilized without distortion even when there is vibration in the lens unit 2 during photographic exposure.

On the other hand, during non-image stabilization control periods when the camera 1 is not in use, the controller 36 moves the moving frame 14 along the protected position motion axis A by sourcing current to each of the drive coils 20a and 20b. As shown in FIG. 6(b) and FIG. 7, in the steel ball 18 protected position the top surface 29a1 contacts the top surface 31a1 and the top surface 29b1 contacts the top surface 31b1, the gap between the fixed portion spherical body receiving surface 28b and the movable portion spherical body receiving surface 30b expands, and the sandwiching force operating on the steel balls 18 goes to zero. The steel ball 18 is thus placed within a space around which the fixed frame concavity 28 outrigger portion 28a and the moving frame concavity 30 outrigger portion 30a overlap, and the steel ball 18 can move freely within this space.

When a shock force acts on the camera in this state, the steel ball 18 is moved within the space and collides with objects such as the fixed portion spherical body receiving surface 28b or the movable portion spherical body receiving surface 30b. In such collisions the shock force applied to the fixed portion spherical body receiving surface and the movable portion spherical body receiving surface is based solely on the inertial force operating on the steel ball 18. Since the mass of the steel ball 18 here is extremely small, the shock force acting on the fixed portion spherical body receiving surface 28b and the movable portion spherical body receiving surface 30b is also extremely small. Damage to the fixed portion spherical body receiving surface 28b and the movable portion spherical body receiving surface 30b is thus prevented.

If image stabilization control is resumed, the controller 36 moves the moving frame 14 in a direction opposite to that in which it was moved to the protected position. The protuberance sloped surface 31a2 and the protuberance sloped surface 31b2 therefore slide down the protuberance sloped surface 29a2 and the protuberance sloped surface 29b2 under the biasing force of the coil springs 26, and the gap between the moving frame 14 and the fixed frame 12 narrows. In this state, each steel ball 18 is sandwiched between the fixed portion spherical body receiving surface 28b and the movable portion spherical body receiving surface 30b, thereby enabling the moving frame 14 to be driven with a small drive force.

In the first embodiment camera of the present invention, the contact pressure sandwiching the steel balls is reduced by the protuberances and brought to zero, so that damage to the steel balls and their receiving surfaces can be prevented when a shock force or the like is applied.

In the camera of the present embodiment, the moving frame is moved to the protected position as the moving frame slides on the protuberance sloped surface, therefore the moving frame can be smoothly moved into the protected position, in which the gap between the fixed portion spherical body receiving surface and the movable portion protuberance receiving surface is expanded.

Furthermore, in the camera of the present embodiment, the steel balls are placed in a state of free movement in the protected position, therefore the position at which the steel balls and the fixed portion spherical body receiving surface and movable portion spherical body receiving surface come in contact varies randomly. Hence, lopsided wear in which only a particular part of the steel ball wears can be prevented.

In the first embodiment described above, protuberances were formed in the protected position so that the gap between the fixed frame and the moving frame was widened, but even when corresponding protuberance top surfaces contact one another, protuberances can be formed at a low height so that the gap between the fixed frame and the moving frame is virtually unchanged. Even when protuberances are thus formed to be low, a portion of the force sandwiching the spherical bodies is supported by the protuberances, thus enabling a reduction in the pressure acting on the spherical bodies. That is, even in such a configuration the gap between the fixed frame and the moving frame can be said to expand microscopically. Such microscopic gap expansions are also encompassed by the “widening the gap between the fixed portion spherical body receiving surface and the movable portion spherical body receiving surface” wording of the present Specification.

Furthermore, in the first embodiment described above, the top surfaces of the protuberances were contacting one another, but each of the spherical body receiving surfaces can also be protected by the state in which the protuberance sloped surfaces contact one another. FIG. 8 is a sectional view showing a variation on the first embodiment of the present invention.

The constitution of the actuator fixed frame 12 and moving frame 14 in the present variation is the same as in the first embodiment described above. That is, the constitution of the fixed frame concavities 28 formed on the fixed frame 12 and the protuberances 29a and 29b formed on both sides thereof, as well as the moving frame concavities 30 formed on the moving frame 14 and the protuberances 31a and 31b formed on both sides thereof are the same as in the above-described first embodiment. In the above-described first embodiment, the sloped surfaces of the protuberances respectively formed on the fixed frame 12 and the moving frame 14 slid on one another when the moving frame 14 was moved toward the protected position, and were placed in the protected position state whereby the protuberance top surfaces did not contact one another. In this variation, the state in which the protuberance sloped surfaces contact one another is assumed to be the protected position.

In other words, as shown in this variation, the position at which the protuberance 29a sloped surface 29a2 comes into contact with the protuberance 31a sloped surface 31b2 and at which the protuberance 29b sloped surface 29b2 comes into contact with the protuberance 31 b sloped surface 31 b2 is deemed to be the protected position. Note that in this instance the steel balls 18 stay in contact with the fixed portion spherical body receiving surface 28b and the movable portion spherical body receiving surface 30b. Moreover, in order to maintain this variation in the state shown in FIG. 8, a moving frame tension spring 40 (schematically shown in FIG. 8) is provided as a protected position biasing means for biasing the moving frame 14 toward the protected position.

The biasing force of this moving frame tension spring 40 causes the moving frame 14 protuberance sloped surface 31a2 and protuberance sloped surface 31b2 to be respectively pressed into the fixed frame 12 protuberance sloped surface 29a2 and the protuberance sloped surface 29b2. Therefore when a shock force or the like operates on a camera 1 generating a load which presses the moving frame 14 against the fixed frame 12, the retaining force sandwiching the steel balls 18 between the fixed portion spherical body receiving surface 28b and the movable portion spherical body receiving surface 30b increases as a result of this load. However, in the protected position shown in FIG. 8, the fixed frame 12 protuberance sloped surfaces 29a2 and 29b2 and the moving frame 14 protuberance sloped surfaces 31a2 and 31b2 are respectively in contact, therefore a portion of the load is shared by their sloped surfaces. As a result, the contact pressure between the fixed portion spherical body receiving surface 28b and the movable portion spherical body receiving surface 30b, and between the steel balls 18 is reduced, therefore damage to the fixed portion spherical body receiving surface 28b and the movable portion spherical body receiving surface 30b is reduced. Consequently in the present variation the protuberance sloped surfaces 31a2 and 31b2 and the protuberance sloped surfaces 29a2 and 29b2 function as load sharing surfaces.

In the present variation the biasing force from the moving frame tension spring 40 acts on the moving frame 14 even during image stabilization control, but the moving frame 14 is driven by a drive force which overcomes this biasing force to execute image stabilization control.

In the camera of the present variation, the steel balls are also sandwiched between the fixed frame and the moving frame in the protected position, therefore movement to the protected position or recovery from the protected position can be quickly implemented.

Next, referring to FIGS. 9 through 12, we discuss a second camera embodiment of the present invention. In the camera of this embodiment, the constitution of the actuator fixed frame concavities and moving frame concavities differs from that of the first embodiment described above. Therefore we discuss only those features which differ from the first embodiment; shared points are assigned the same reference numerals and omitted from the discussion.

FIG. 9 is a plan view of a fixed frame concavity formed on a fixed frame built into the camera of the present embodiment. FIG. 10 is a plan view of a moving frame concavity formed on a moving frame built into the camera of the present embodiment. FIG. 11 is a sectional view along line XI-XI in FIG. 9, showing the actuator in (a) the operational center position and (b) the protected position. FIG. 12 is a plan view showing a fixed frame concavity and a moving frame concavity in the protected position.

As shown in FIG. 9, the fixed frame concavity 228 is a concavity with a generally circular cross-section formed on the fixed frame 12 plane portion 12a, constituted so that the steel balls 18 are disposed within this concavity. An outrigger portion 228a protruding in the direction of the protected position motion axis A so as to bulge out at the end is formed at one location on the perimeter of the fixed frame concavity 228, and the planar bottom surface of the fixed frame concavity 228 constitutes the fixed portion spherical body receiving surface 228b which contacts the steel ball 18. A spherical body escape concavity 229, which is a circular depression, is formed on the bottom surface of the outrigger portion 228a of the fixed frame concavity 228.

As shown in FIG. 10, a moving frame concavity 230 is a concavity generally circular in section, formed on the plane portion 14a of the moving frame 14, constituted so that the steel ball 18 is disposed within this concavity. An outrigger portion 230a protruding so as to bulge out at the end is formed at one location on the perimeter of the moving frame concavity 230, and the planar bottom surface on the moving frame concavity 230 constitutes a movable portion spherical body receiving surface 230b which contacts the steel ball 18. Moreover, a spherical body escape concavity 231, which is a circular depression, is formed on the bottom surface of the outrigger portion 230a of the moving frame concavity 230.

As shown in FIG. 11(a), when the actuator 10 executes image stabilization control, the steel balls 18 are sandwiched between the fixed frame concavity 228 fixed portion spherical body receiving surface 228b and the moving frame concavity 230 movable portion spherical body receiving surface 230b. In this state, there is a gap between the fixed frame 12 plane portion 12a and the moving frame 14 plane portion 14a, and these portions never come into contact. In the movement range within which the moving frame 14 is moved by image stabilization control, the steel balls 18 never fall into the spherical body escape concavity 229 formed on the fixed portion spherical body receiving surface 228b or the spherical body escape concavity 231 formed on the movable portion spherical body receiving surface 230b.

Next, when the moving frame 14 is moved in what is shown as the lateral direction in FIG. 11(a) along the protected position motion axis A, the steel ball 18 rolls toward the spherical body escape concavity 229 and the spherical body escape concavity 231. When the moving frame 14 is moved up to the protected position, the spherical body escape concavity 229 and the spherical body escape concavity 231 overlap, as shown in FIG. 11(b). In this state, as shown in FIG. 12, the steel ball 18 is positioned in the portion where the spherical body escape concavities 229 and 231 overlap. The gap between the bottom portion of the spherical body escape concavity 229 and the bottom portion of the spherical body escape concavity 231 is wider here than the diameter of the steel ball 18, so the fixed frame 12 plane portion 12a and the moving frame 14 plane portion 14a contact directly due to the biasing force of the coil springs 26. In this state, the retaining power sandwiching the steel balls 18 between the fixed portion spherical body receiving surface 228b and the movable portion spherical body receiving surface 230b declines to zero.

Moreover, as shown in FIG. 12, in the protected position the steel ball 18 is moved to the relatively small space where the fixed frame concavity 228 outrigger portion 228a and the moving frame concavity 230 outrigger portion 230a overlap, and is able to move freely within this space.

When a shock force acts on the camera 1 in this state, the steel ball 18 is moved within the space, and the fixed portion spherical body receiving surface 228b collides with such items as the movable portion spherical body receiving surface 230b. The shock force acting on the fixed portion spherical body receiving surface and the movable portion spherical body receiving surface in this collision is based solely on the inertial force acting on the steel ball 18, and is very small. Damage to the fixed portion spherical body receiving surface 228b and the movable portion spherical body receiving surface 230b can thus be avoided.

When again restored to image stabilization control, the controller 36 moves the moving frame 14 in a direction opposite to that used when it was moved to the protected position. The steel ball 18 thus rolls out from the spherical body escape concavities 229 and 231 and is sandwiched once again between the fixed portion spherical body receiving surface 228b and the movable portion spherical body receiving surface 230b, as shown in FIG. 11(a).

In the second embodiment camera of the present invention, the fixed frame plane portion and the moving frame plane portion make direct contact in the protected position, therefore the actuator can be compactly constituted without the thickness of the actuator becoming too thick in the protected position.

Also, in the camera of the present embodiment, the steel ball is placed in a freely movable state in the protected position, and the position at which the steel ball makes contact with the fixed portion spherical body receiving surface and the movable portion spherical body receiving surface changes randomly. This permits the prevention of eccentric wear by which only certain locations on the steel balls are worn.

Next, referring to FIGS. 13 through 17, we discuss a camera according to a third embodiment of the invention. The camera of this embodiment differs from the above-described first and second embodiments in the constitution of its built-in actuator fixed frame and moving frame concavities. Therefore we will here discuss only the points in the embodiment which differ from the first and second embodiments, assigning the same reference numerals to the same features and omitting a discussion thereof.

FIG. 13 is a plan view of the fixed frame built into the camera of the present embodiment. FIG. 14 is a plan view of the moving frame concavity formed on the moving frame built into the camera of the present embodiment. FIG. 15 depicts a cross section along line XV-XV in FIG. 13 at (a) the actuator operational center position and (b) the protected position. FIG. 16 is a plan view showing the fixed frame concavity and the moving frame concavity at the protected position. FIG. 17 is a cross section along line XVII-XVII in FIG. 16.

As shown in FIG. 13, a fixed frame concavity 328 is a concavity with a generally circular cross section formed on the fixed frame 12, arranged so that a steel ball 18 is disposed within the concavity. At one location on the perimeter of the fixed frame concavity 328, a spherical body support surface portion 328 protruding in the direction of the protected position motion axis A is formed in a ¼ sphere shape of approximately the same diameter as the steel ball 18, and the planar bottom surface of the fixed frame concavity 328 constitutes a fixed portion spherical body receiving surface 328b which contacts the steel ball 18.

At the same time, as shown in FIG. 14, a moving frame concavity 330 is a concavity with a generally circular cross section formed on the moving frame 14, arranged so that the steel ball 18 is disposed within this concavity. At one location on the perimeter of the moving frame concavity 330, a spherical body support surface portion 330a protruding in the direction of the protected position motion axis A is formed in a ¼ sphere shape of approximately the same diameter as the steel ball 18, and the planar bottom surface of the moving frame concavity 330 constitutes a movable portion spherical body receiving surface 330b which contacts the steel ball 18. The spherical body support surface portion 330a is formed so as to protrude in the opposite direction to that of the fixed frame concavity 328 spherical body support surface portion 328a.

As shown in FIG. 15(a), when the actuator 10 executes image stabilization control the steel ball 18 is sandwiched between the fixed frame concavity 328 fixed portion spherical body receiving surface 328b and the moving frame concavity 330 movable portion spherical body receiving surface 330b. Note that in the range within which the moving frame 14 is moved under image stabilization control, the steel ball 18 is not moved into the spherical body support surface portion 328a contiguous with the fixed portion spherical body receiving surface 328b or the spherical body support surface portion 330a contiguous with the movable portion spherical body receiving surface 330b.

Next, when the moving frame 14 is moved in what is shown in FIG. 15(a) as the lateral direction along the protected position motion axis A, the steel ball 18 rolls toward the spherical body support surface portions 328a and 330a. When the moving frame 14 is moved to the protected position, the spherical body support surface portion 328a and the spherical body support surface portion 330a are placed in adjacent positions as shown in FIGS. 15(b) and 16. In this state, as shown in FIG. 15(b) and FIG. 17, the steel ball 18 makes surface contact with the spherical body support surface portions 328a and 330a. The spherical body support surface portions 328a and 330b are here formed in a spherical shape with approximately the same diameter as the steel ball 18, therefore the contact surface areas between the steel ball 18 and the spherical body support surface portions 328a and 330a are respectively approximately ¼ of the surface area of the steel ball 18. Hence the steel ball 18 is supported by an area approximately one half its surface area. The steel ball 18, which had been making point contact with the fixed portion spherical body receiving surface 328b and movable portion spherical body receiving surface 330b, thus contacts the spherical body support surface portions 328a and 330a over a very broad surface area, enabling a reduction in the contact pressure sandwiching the steel ball 18.

In the camera of the third embodiment of the present invention, the steel ball contacts the spherical body support surface portion over a broad area, therefore the contact pressure retaining the steel ball can be reduced, and the steel ball can be held in place.

We have discussed preferred embodiments of the present invention, but various changes could also be applied to the above-described embodiments. In particular, in the embodiments discussed above the present invention was applied to a film camera, but the present invention could also be freely applied to any desired camera used for still or moving picture imaging, such as digital cameras, video cameras, and the like.

In the embodiments discussed above, the protected position was set up in a position to which the moving frame was translated from the image stabilization control operational center position, but the protected position can also be set up at a position to which the moving frame is rotated from the operational center position. In such cases, the fixed frame concavity and the moving frame concavity can be formed in such a way that the protected position motion axis is directed in a direction tangential to a circle centered on the optical axis.

### BRIEF DESCRIPTION OF FIGURES

FIG. 1 A cross section of a camera according to a first embodiment of the present invention.

FIG. 2 A front elevation of an actuator with a moving frame in the image stabilization control operation center position.

FIG. 3 A side elevation cross section along line III-III in FIG. 2.

FIG. 4(a): a plan view of a fixed frame concavity; (b): a cross section along line b-b in (a).

FIG. 5(a): a plan view of a moving frame concavity; (b): a cross section along line b-b in (a).

FIG. 6 A figure showing a cross section along line VI-VI in FIG. 2 at (a) the actuator operational center position and (b) the protected position.

FIG. 7 A plan view showing the fixed frame concavity and the movable portion spherical body receiving surface at the protected position.

FIG. 8 A cross section showing a variation on the first embodiment of the present invention.

FIG. 9 A plan view of a fixed frame concavity formed on a fixed frame built into a camera according to a second embodiment of the present invention.

FIG. 10 A plan view of a moving frame concavity formed on a moving frame built into a camera according to a second embodiment of the present invention.

FIG. 11 A figure showing a cross section along line XI-XI in FIG. 9 in (a) the actuator operational center position, and (b) at the protected position.

FIG. 12 A plan view showing the fixed frame concavity and the moving frame concavity in the protected position.

FIG. 13 A plan view of a fixed frame concavity formed on a fixed frame built into a camera according to a third embodiment of the present invention.

FIG. 14 A plan view of a moving frame concavity formed on a moving frame built into a camera according to a third embodiment of the present invention.

FIG. 15 A figure showing a cross section along line XV-XV in FIG. 13 in (a) the actuator operational center position, and (b) at the protected position.

FIG. 16 A plan view showing the fixed frame concavity and the moving frame concavity in the protected position.

FIG. 17 A cross section along the line XVII-XVII in FIG. 16.

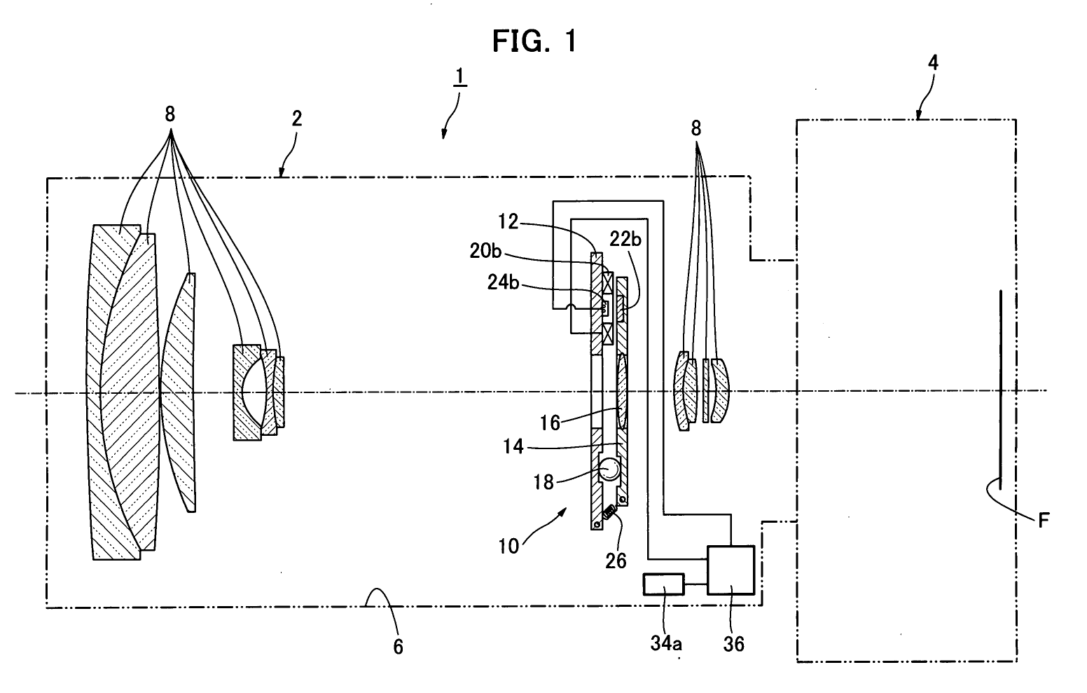

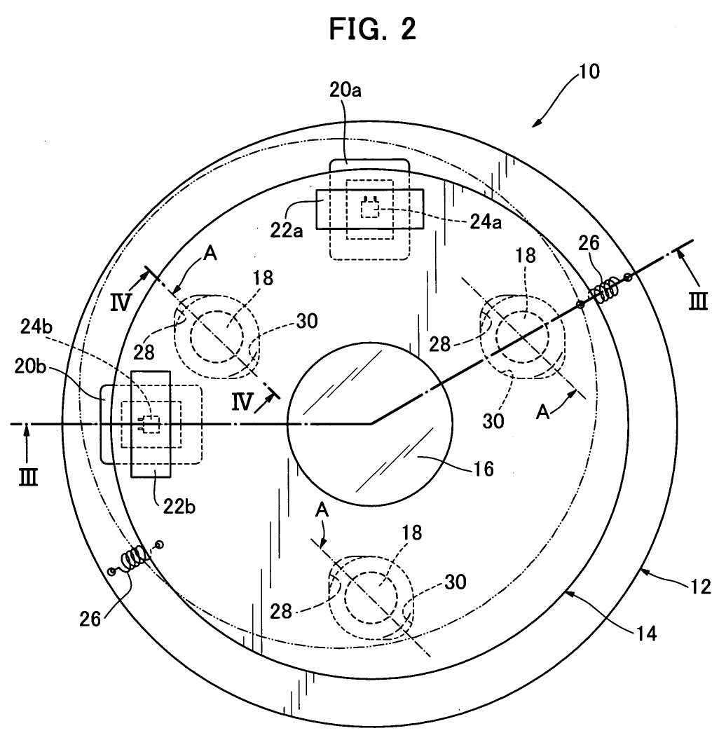

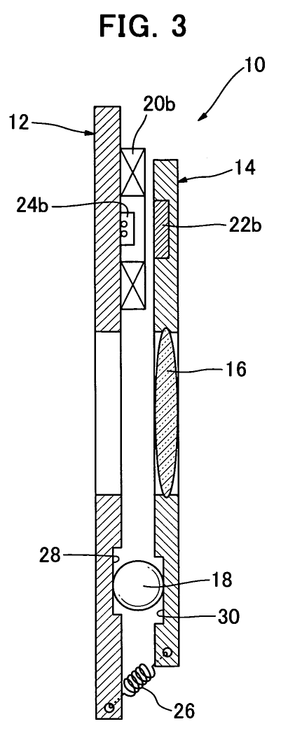

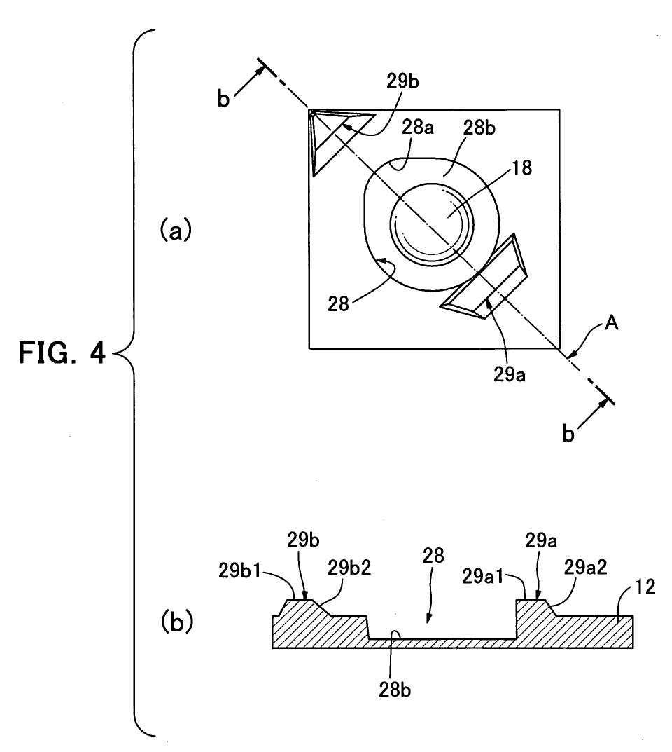

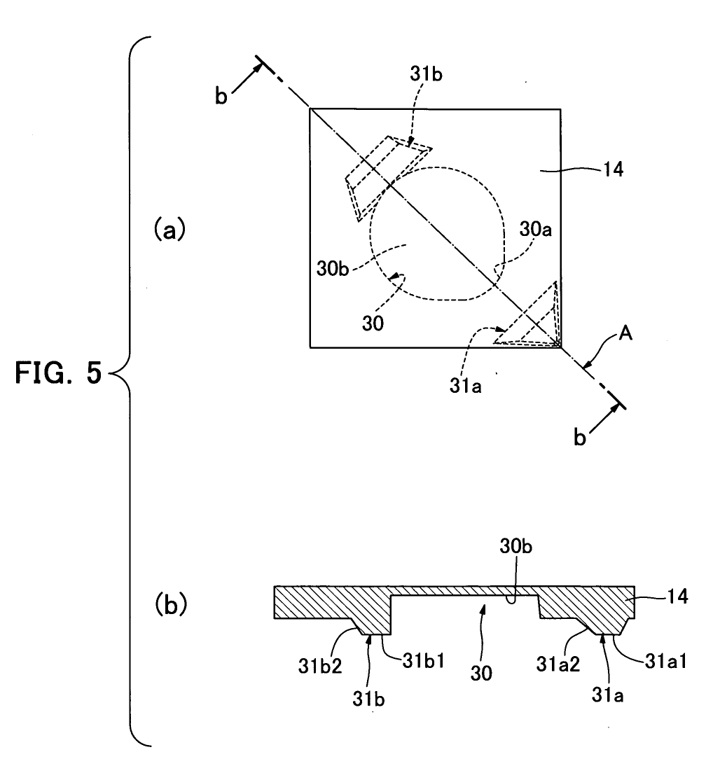

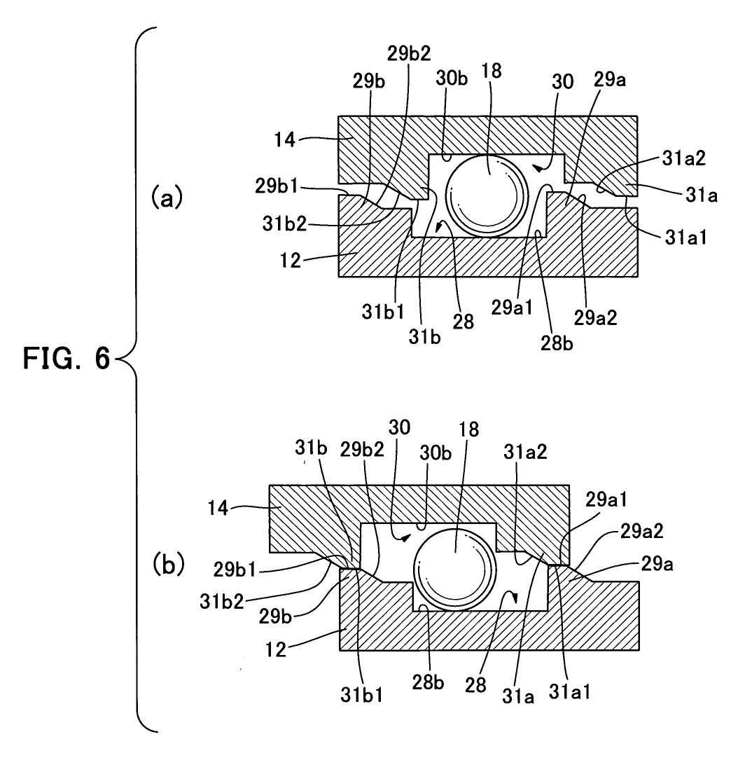

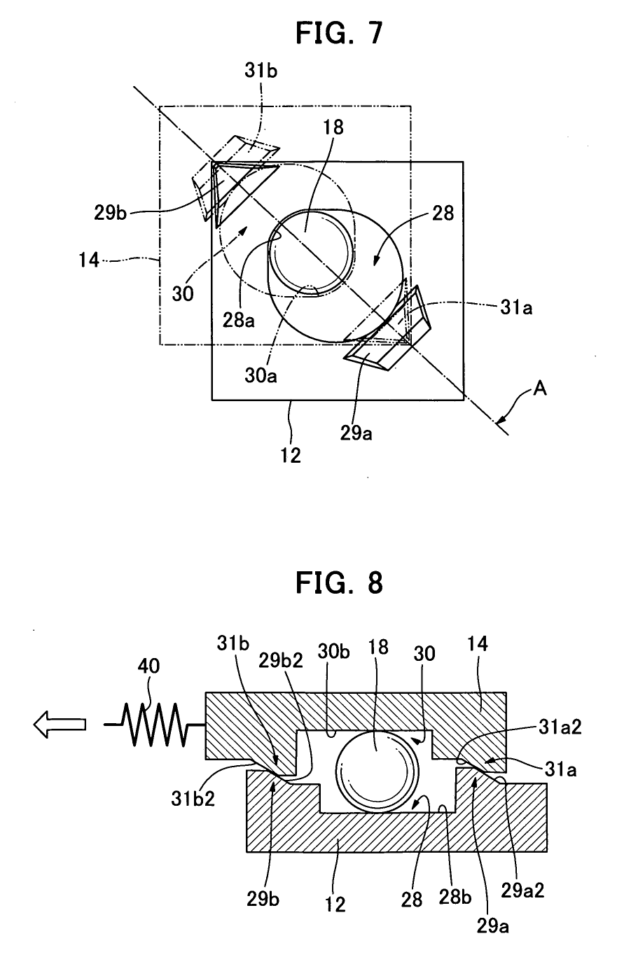

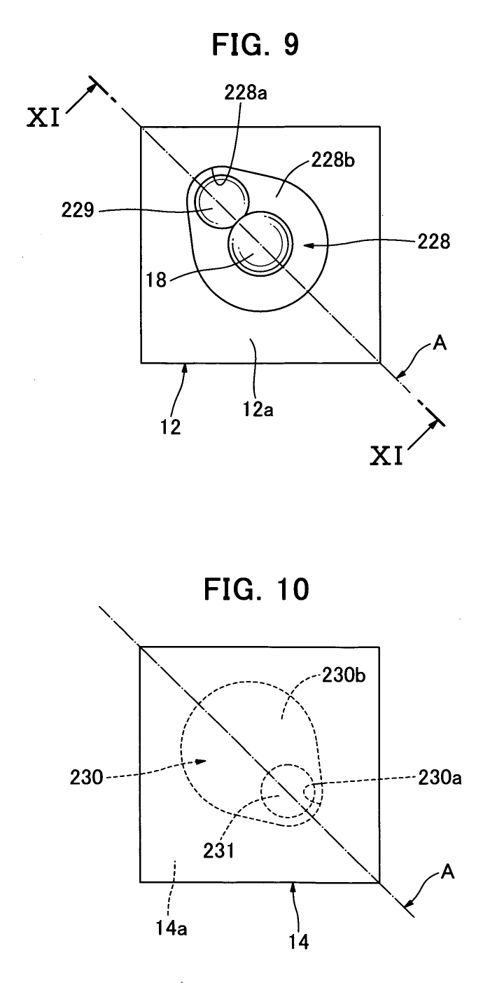

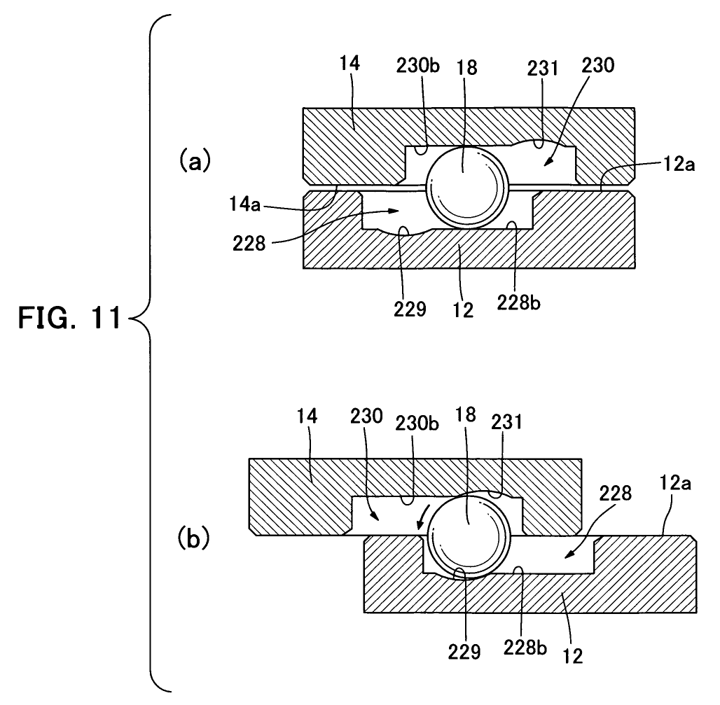

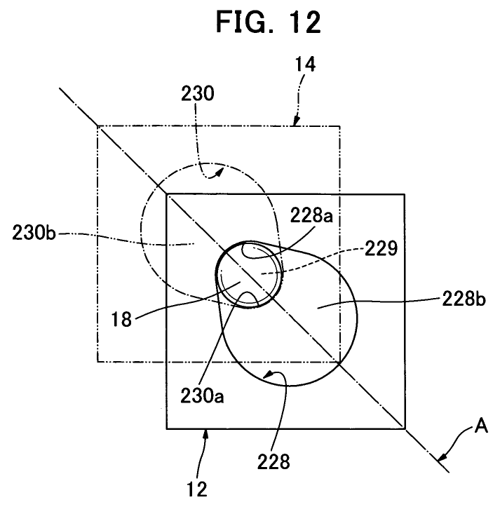

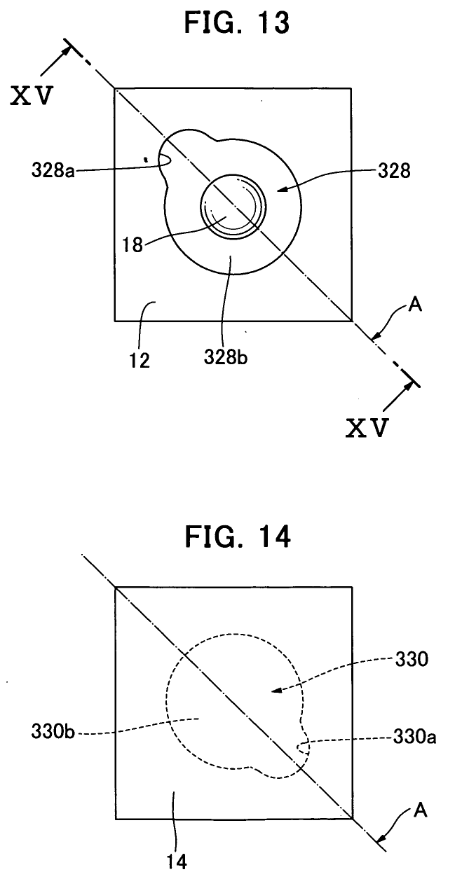

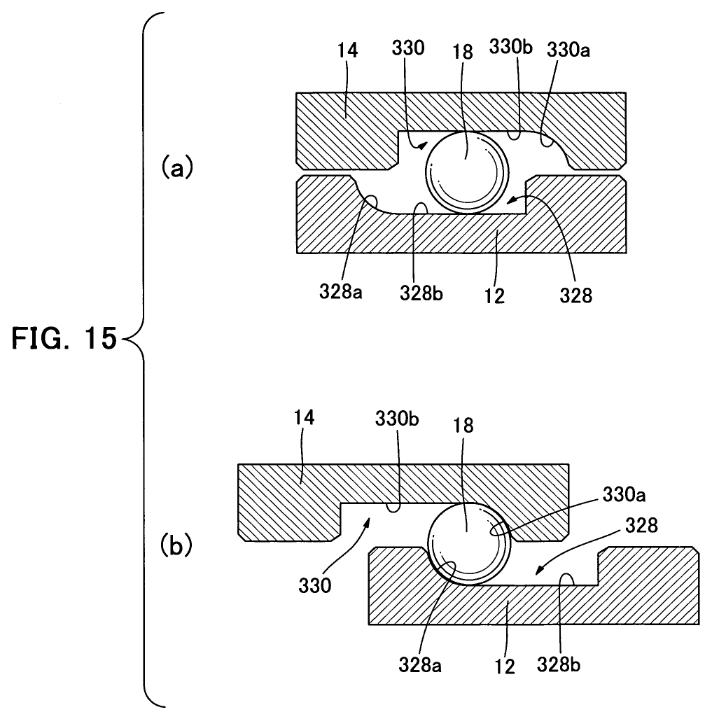

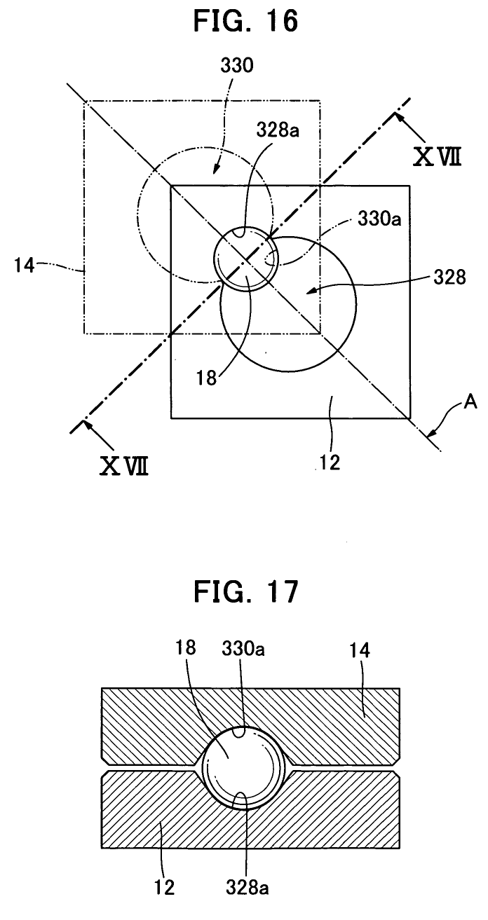

1 A camera according to a first embodiment of the present invention.
2 Lens unit
4 Camera main body
6 Lens barrel
8 Imaging lens
10 Actuator
12 Fixed frame (fixed portion)
12a Planar portion
14 Moving frame (movable portion)
14a Planar portion
16 Image blur compensation lens
18 Steel ball (spherical body)
20a, 20b Drive coils
22a, 22b Drive magnets
24a, 24b Hall elements
26 Coil spring (biasing means)
28 Fixed frame concavity
28a Outrigger portion
28b Fixed portion spherical body receiving surface
29a, 29b Protuberances (spherical body receiving surface protection means)
29a1 Top surface
29a2 Protuberance sloped surface
29b1 Top surface
29b2 Protuberance sloped surface
30 Moving frame concavity
30a Outrigger portion
30b Moving portion spherical body receiving surface
31a, 31b Protuberances
31a1 Top surface
31a2 Protuberance sloped surface
31b1 Top surface
31b2 Protuberance sloped surface
34a, 34b Gyros
36 Controller
40 Moving frame tension spring (protected position biasing means)
228 Fixed frame concavity
228a Outrigger portion
229 Spherical body escape concavity
230 Moving frame concavity
230a Outrigger portion
230b Moving portion spherical body receiving surface
231 Spherical body escape concavity
328 Fixed frame concavity
328a Spherical body support surface portion
328b Fixed portion spherical body receiving surface
330 Moving frame concavity
330a Spherical body support surface portion
330b Moving portion spherical body receiving surface

1. An actuator for moving an imaging lens within a plane perpendicular to its optical axis to prevent image blurring, the actuator comprising:
a fixed portion;
a movable portion to which the imaging lens is attached;
a plurality of spherical bodies supporting the movable portion in such a way that it can move on a plane parallel to the fixed portion;
a drive means for driving the movable portion with respect to the fixed portion;
a fixed portion spherical body receiving surface disposed on the fixed portion and contacting the spherical bodies;
a movable portion spherical body receiving surface disposed on the movable portion and contacting the spherical bodies;
a biasing means for generating a biasing force to cause the movable portion and the fixed portion to approach one another to sandwich the spherical bodies between the fixed portion spherical body receiving surface and the movable portion spherical body receiving surface; and
a spherical body receiving surface protection means to reduce contact pressure acting on the spherical bodies to sandwich the spherical bodies when the movable portion is moved to a predetermined protected position and not under image stabilization control.

2. The actuator according to claim 1, the spherical body receiving surface protection means comprising protuberances formed on the movable portion and the fixed portion, the protuberances contacting one another when the movable portion is moved to the protected position, thereby widening the gap between the fixed portion spherical body receiving surface and the movable portion spherical body receiving surface.

3. The actuator according to claim 2, wherein the protuberance is provided with a protuberance sloped surface, formed to connect to the top surface thereof, so that the movable portion is moved to the protected position as it slides on the protuberance sloped surface to widen the gap between the fixed portion spherical body receiving surface and the movable portion spherical body receiving surface.

4. The actuator according to claim 1, wherein the spherical body receiving surface protection means comprises a spherical body escape concavity formed in such a way that the spherical body escape concavity connects to at least either the fixed portion spherical body receiving surface or the movable portion spherical body receiving surface, and the spherical bodies are moved to the spherical body escape concavity when the movable portion is moved to the protected position, placing the fixed portion and the movable portion in direct mutual contact.

5. The actuator according to claim 1, wherein the spherical body receiving surface protection means comprises a protected position biasing means for biasing the movable portion toward the protected position, and load sharing surfaces respectively provided on the fixed portion and the movable portion, and wherein the load sharing surfaces are pushed against one another by means of a biasing force from the protected position biasing means.

6. The actuator according to claim 1, wherein the spherical body receiving surface protection means comprise a spherical body support surface portion formed to connect with at least one of the movable portion spherical body receiving surface and the fixed portion spherical body receiving surface, wherein the spherical body support surface portion contacts the spherical body when the movable portion is moved to the protected position, and wherein the contact surface area between the spherical body support surface portion and the spherical body is greater than the contact surface area between the fixed portion spherical body receiving surface or the movable portion spherical body receiving surface and the spherical body.

7. A camera, comprising:
a lens barrel;
a plurality of imaging lenses housed within the lens barrel;
the actuator according to claim 1 wherein at least one of these imaging lenses is attached to the movable portion; and
a camera main body.
